(19) United States
(12) Patent Application Publication
(10) Pub. No.: US 2005/0091317 A1
(43) Pub. Date: Apr. 28, 2005

(54) System and method fo producing and processing messages in automation systems

(76) Inventor: Michael Schlereth, Wilhermsdorf (DE)

Correspondence Address: STAAS & HALSEY LLP, SUITE 700, 1201 NEW YORK AVENUE, N.W., WASHINGTON, DC, 20005, US

(21) Appl. No.: 10/505,074

(22) PCT Filed: Jun. 20, 2003
(86) PCT No.: PCT/DE03/02068

(30) Foreign Application Priority Data
Jul. 2, 2002 (DE) 10229637.5

(51) Int. Cl. G06F 15/16

(52) U.S. Cl. 709/206; 709/203

(57) ABSTRACT

A system and a method transmit and process messages, in terms of the automation of a production plant. The messages are sent from the automation appliances to an internet message server by a data transmission system in the form of the Internet or an Intranet. The Internet message server serves the receiver and the distributor of the messages. The actual addressee of the message is determined on the server by distribution lists, and the message is forwarded to the addressees, directly or by a processing unit which adds further information to the message. The messages are stored in baskets and can be buffered. A confirmation message can be sent from the addressees to the automation appliance.

### CROSS REFERENCE TO RELATED APPLICATIONS

This application is based on and hereby claims priority to PCT Application No. PCT/DE2003/002068 filed on Jun. 20, 2003 and German Application No. 102 29 637.5 filed on Jul. 2, 2002, the contents of which are hereby incorporated by reference.

### BACKGROUND OF THE INVENTION

The invention relates to a system and a method for producing and/or processing a message from a control apparatus and/or from an automation appliance via the intranet and/or the Internet.

In production plants, the automation appliances, i.e. the control apparatuses and the automation appliances, produce, during operation, messages which are sent either to human users or to other apparatuses which are present in the systems. The messages produced by the automation appliances may be either alarms triggered in the event of plant faults or messages which are produced during normal plant operation. These may be, by way of example, the cyclic reporting of process data for trend analyses. Depending on the addressee of the message, it is necessary to add additional information to the respective message before forwarding to the addressee. This additional information may be, by way of example, texts which are added to a message number. The messages are normally not sent unidirectionally from the sender to an addressee; rather, in contrast, the message receiver returns a response in the form of an acknowledgement to the message sender. Today, the messages from the automation appliances are commonly processed using operating and observation systems. Within the systems, there are “message servers” which receive the message and provide it with additional information and possibly forward it to an addressee. In this context, exclusively plant-internal access to the transmitted messages is possible.

DE 198 37 650 A1 discloses a system, a method and a control apparatus for producing a message as an e-mail via the Internet or intranet. In this context, the e-mail is provided with an address and is sent directly to the receiver.

### SUMMARY OF THE INVENTION

One aspect of the invention is based on the object of specifying a system and a method which easily produce and process a message from a control apparatus or from an automation appliance.

This object may be achieved by a system for producing and/or processing a message from a control apparatus and/or from an automation appliance via a data transmission system to a reception apparatus which can be coupled to the data transmission system, the reception apparatus has a receiver the message sent by the control apparatus and/or by the automation appliance, which system is characterized in that the reception apparatus is in the form of a message server and in that the message server is provided for receiving messages from all control apparatuses and/or automation appliances which are present in the system.

The inventor realized that it is increasingly important to process messages which are produced by automation appliances in plants using a system which is as universal as possible and acts as a message server. Such a universal system for holding and forwarding messages requires no special alignment of the interfaces, as is still necessary today in the operating and observation systems used, when units for processing the messages further are connected. In addition, the system provides the opportunity for all control apparatuses which are present in the system to send their messages to one message server. This greatly simplifies the processing of the messages and also the configuration of the automation appliances, since an automation appliance only ever sends its messages to just one message server and also receives the responses from this server. Complex addressing of the messages is not necessary. The use of one message server to process automation messages thus results in an improvement both in plant operation and in the configuration of the plant.

One advantageous form is characterized in that the data transmission system provided is an intranet and/or an Internet. If, in addition to a universal message server, an intranet or an Internet is used for receiving and forwarding messages for data transmission, then a user of a plant is also able to access the messages remotely via the network, particularly the Internet. Remote integration regarding process values or obtaining information in the event of a plant fault where an alarm is reported would be possible for a production supervisor or service technician who is not on site. The use of the intranet or Internet saves costs and increases flexibility.

A further advantageous form is characterized in that the message server is in the form of an Internet message server. This allows the server to be installed at any point in the network and, in addition an Internet message server requires no special protocol, but rather can use the standard Internet protocol when handling the messages.

A further advantageous form is characterized in that the Internet message server is in the form of an e-mail server for asynchronous interchange of messages. The messages sent by the automation appliances are automatically buffered on the server in an in-tray until they can be sent to the actual addressee or can be fetched by him. The addressees do not need to be permanently connected to the message server by the buffer system via a data link. Rather, the messages can be fetched from the server at any time. This is also advantageous particularly if an addressee is in an operative state. In this case, the message is not lost but rather is provided in the server's mail tray until the data link is restored or the message receiver is present in the system again. This prevents loss of messages.

A further advantageous form is characterized in that the Internet message server is in the form of an instant message system for synchronous interchange of messages. In the case of this form, the messages can also be interchanged approximately synchronously between the automation appliances and the receivers. In the case of messages with critical timing, this is advantageous, since there is no delay to the forwarding of the message as a result of buffer-storage in a mail tray on the server.

A further advantageous form of the invention is characterized in that the messages are assigned to at least one addressee are provided. In this context, the messages which have been received on the message server from the automation appliances are assigned to the respective intended addressees using a distribution list on the basis of keys which are appended to the messages. The particular advantage of the central storage of the distribution lists on the server is that the distribution lists can easily be maintained centrally. The automation appliances do not need to be informed of any additional information about newly added message receivers or new addresses of receivers via a configuration interface. The automation appliances only ever send their messages to one address, namely the server, on which the messages are then placed into the appropriate outgoing mailboxes for the addressees. Instead of updating the addresses on each automation appliance involved, only the distribution list stored on the server needs to be updated in the event of alteration of the addressees. Complex and time-intensive configuration work is thus dispensed with.

A further advantageous form is characterized in that the control apparatus and/or the automation appliance has means for receiving a confirmation message which is returned from the reception apparatus to the control apparatus and/or to the automation appliance and an acknowledgment unit to automatically mark a message as acknowledged. This means that the sender can be notified that the message sent has actually reached the intended receiver. In addition, the sender can confirm that he has taken note by an acknowledgement. The opportunity to set up such a feedback process in the system simplifies the handling of message transmission, since the individual appliances involved are informed about the respective status. In addition, it becomes possible to document the information transmission between the appliances involved. Such a feedback process thus simplifies the correct handling of the communication between the appliances.

A further advantageous form is characterized in that an appending unit processes a message by adding further information can be coupled to the message server. A large portion of the messages received normally requires further processing, i.e. texts or additional information is/are added to the messages. Complex further processing operations may also be performed on the messages, these possibly involving, by way of example, the processing unit using an error tree to ascertain the cause of error for a fault signal and forwarding the cause of error in text form to a service technician.

A further advantageous form is characterized in that the appending unit is identified using mailboxes and/or message channels. The advantage of the inventive form is that no special alignments on the interfaces or on the data transmission systems need to be made between the message server and the units for further processing. Any processing units which are on the market and which use standard e-mail or standard instant messaging interfaces can be coupled to the Internet message server. Complex programming of specific interfaces is dispensed with.

A further advantageous form is characterized in that the appending unit forwards the message to a person and/or to further apparatuses which are present in the system. In this way, it is possible, by way of example, for a service engineer or a user of the plant to be informed about specific alarm or fault signals which have been provided with additional information. The precise cause of error can be communicated to the service engineer using the additional information and can also be forwarded to him at the same time by the processing unit. However, this form also affords the opportunity to send, by way of example, process data to a system for historical data management which collects the process values from all automation appliances involved in the system, archives them and possibly even evaluates them statistically. In the system, the messages can be accessed using the normal interfaces, that is to say either by humans using e-mail or messenger clients or by machines. The most universal supply of information possible is ensured in this case.

A further advantageous form is characterized in that the person and/or an apparatus sends a message response and/or acknowledgement to a message to the control apparatus and/or to the automation appliance. The advantage in this context is that the final receiver is put into a position to confirm receipt of the message independently, either as a person or as an apparatus in the system. It is thus merely necessary to confirm when confirmation of receipt is actually necessary. Superfluous confirmations are unnecessary, which results in a reduction in the flow of data in the system's network. The response by the person or the apparatus can be processed by the coupled processing units, like the message. The automation appliance thus receives specific feedback relating to its original message.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic illustration of an exemplary embodiment of the system for producing and processing a message from an automation appliance via an intranet or Internet using an Internet message server.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

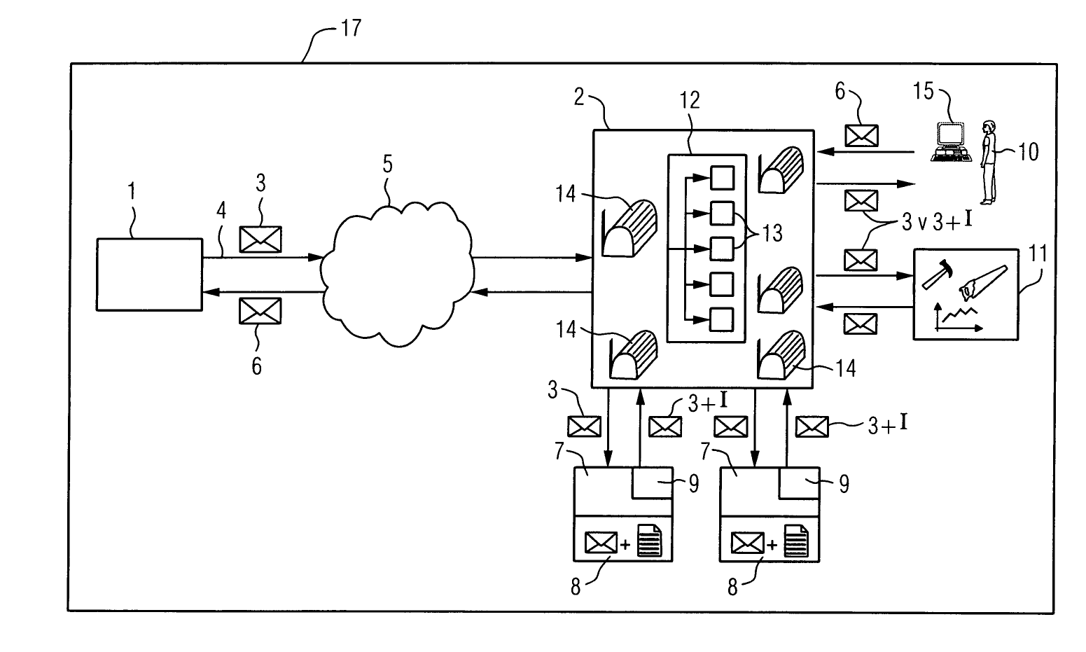

FIG. 1 shows a schematic illustration of an exemplary embodiment 17 for producing and processing a message 3, the message 3 being sent via a data transmission system 4 to the Internet message server 2, which serves as a reception apparatus. In this context, the data transmission system 4 is in the form of an intranet or Internet 5. The Internet message server 2 has a mail in-tray 14 which receives the messages. The intranet message server 2 also has “distribution lists” 12 which are used to assign the received messages to the addressees 13. The intranet message server 2 has processing units 7 coupled to it which are able to receive messages 3 for further processing. The processing devices 7 have appending units 8 which can be used to add additional information to the messages 3. The processed information can then be forwarded via the intranet message server 2 to further receivers, which may be either people 10 or apparatuses 11 which are present in the system 17, using unit 9 for forwarding. Using device 15, a message response or acknowledgment 6 is sent to the automation appliance 1, from either a person 10 or an apparatus 11.

The particular feature of the system 17 shown in FIG. 1 is, essentially, that all automation appliances or controllers 1 which are present in the system 17 send their messages to one Internet message server 2 centrally. The use of the Internet or intranet 5 for data transmission, that is to say sending the messages 3, means that there is no need for complex programming of specific interfaces, as is currently the norm when using an operating and observation appliance as a reception unit 2 for messages. In addition, the use of a universal Internet message server 2 allows a practice in which all automation appliances 1 involved are always able to send their messages to the same addressee, namely the intranet message server 2, without further indication of addresses. Complex configuration in the event of an address change or a change to distribution lists 12 on the individual automation appliances 1 is dispensed with. All in all, the system 17 described in FIG. 1 allows great simplification and improvement of the sending and processing of messages 3 at the automation level in plants.

The use of the Internet or intranet 5 also permits authorized parties involved to access the messages from outside of the system 17. This is advantageous particularly when handling an alarm signal, since a service technician, who may not be directly at the plant, is informed about the condition by normal e-mails and learns about alarms. The service technician can sometimes perform a diagnosis directly from a distance using the information with which he has been provided in the message, and may issue appropriate instructions to the personnel who are present at the plant. The use of the system 17 means that expert knowledge does not need to be available directly on site at all times. Remote requesting of process values via Internet and e-mail is also possible in this way, which ensures overview and control of the production cycles from outside of the plant.

The use of the Internet message server 2 as an e-mail server allows the received messages 3 to be buffered a mail tray 14 until the addressees fetch their messages 3. This is beneficial particularly in the case of messages 3 which are intended for people who are able to retrieve these messages 3 easily and at any time via an e-mail client. Another advantage, however, is that messages can be buffered for further apparatuses 11 or for processing units 7 until the receivers are ready to receive the messages, since this prevents any loss of the received messages in the event of potential failure of one of the units 7 or 11 involved. The messages are also assigned at a later time, when the systems are running again.

The exemplary embodiment shown in FIG. 1 is also advantageously distinguished by virtue of the distribution lists 12 for the individual addressees 13 being located centrally on the universal Internet message server 2 and thus also being able to be maintained and managed centrally. Complex maintenance of individual distribution address lists on the automation appliances 1 involved, which would need to be performed for the respective individual automation appliance 1, is not necessary. The distribution list 12 is used to distribute the messages 3 to the addressees 13. Within the Internet message server, the messages are then put into the mail trays 14 assigned to the addressees 13. From these mail trays 14, the messages can be fetched the processing units 7 further or by people 10 or by further apparatuses 11 in the system 17. When the message has been processed or when the message 3 has been received, confirmation responses or acknowledgements 6 can be returned via the Internet message server 2 and the Internet 5 to the automation appliance 1 which originally generated a message 3. The option for acknowledgement means that the automation appliance 1 knows that its message has reached its receiver and that it does not need to store the message further or to send it again.

Another advantage in the exemplary embodiment shown is that further units 7 for processing the messages 3 further are coupled to the Internet message server 2. In these processing units, the messages 3 can have further information 8 added to them which is then returned via a forwarding apparatus 9 to the Internet message server 2 and may be forwarded from there to an addressee. The processing units 7 allow texts, for example, to be added to the messages 3. Alternatively, complex handling of the messages 3 is possible, this involving, by way of example, a key which is appended to the message 3, particularly to a fault signal, being taken as a basis for searching for a cause of error which can be associated with the fault signal within an error tree or using another search scheme, and the cause of error being able to be appended to the message. The message 3 provided with this information can then be forwarded to a service technician or to a servicing system on the plant. Altogether, the processing units 7 can provide important additional information 8 which simplifies the interpretation of the messages 3 and thus increases their value. This information 8 cannot readily be added to the messages 3 by an automation appliance 1 with little complexity. People 10 or else apparatuses 11 such as plant information systems, which record a history of the process data and evaluate the data statistically, or plant servicing systems, which automatically generate servicing orders, benefit from these messages 3 provided with additional information 8. The use of the Internet message server 2 with the opportunity to connect processing units 7 improves the quality of the messages 3 overall. Personal forwarding by a user of an operating and observation appliance is not necessary in this case, since the message 3 is forwarded automatically. However, a user of the plant can use an e-mail client 15 at any time to view the messages 3 handled via the Internet message server 2 and to download the appropriate data, for example process values.

The use of an Internet message server 2 also allows further such servers to be coupled in the system 17 as desired, the servers being able to be positioned centrally on a plant or in a computer center or else locally at arbitrary locations with Internet access. This means that there is central processing of large volumes of data using a single system 17 comprising a plurality of modules.

In summary, a system 17 and a method send and process messages 3 at the automation level in the production plant. The messages are sent from the automation appliances 1 to an Internet message server 2 via a data transmission system 4, which is in the form of an Internet or intranet 5. The Internet message server serves receiver and distributor of the messages 3. On the server 2, distribution lists 12 are used to ascertain the actual addressee 13 of the message 3, and the message 3 is forwarded to the addressee 11, 15 directly or via a processing unit 7, which adds further information 8 to the message 3. The messages 3 are stored in mail trays 14 and can be buffered. The addressee is able to send a confirmation message 6 to the automation appliance 1.

The invention has been described in detail with particular reference to preferred embodiments thereof and examples, but it will be understood that variations and modifications can be effected within the spirit and scope of the invention.

1-22. (canceled)

23. A system for producing and/or processing a message, comprising:
a plurality of control and/or an automation apparatuses to send messages;
a data transmission system to transmit the messages; and
a message server coupled to the data transmission system to receive the messages sent by the control and/or automation apparatuses, the message server being provided for receiving messages from all control and/or automation apparatuses of the system.

24. The system as claimed in claim 23, wherein the data transmission system comprises an intranet and/or an Internet.

25. The system as claimed in claim 23, wherein the message server is an Internet message server.

26. The system as claimed in claim 25, wherein the Internet message server is an e-mail server for asynchronous interchange of messages.

27. The system as claimed in claim 25, wherein the Internet message server is in the form of an instant messaging system for synchronous interchange of messages.

28. The system as claimed in claim 23, further comprising an address unit to assign the messages to at least one addressee.

29. The system as claimed in claim 23, wherein
the control and/or the automation apparatuses have a receiver to receive a confirmation message which is returned from the message server, and
the control and/or automation apparatuses have an acknowledgment unit to automatically mark a message as acknowledged.

30. The system as claimed in claim 25, further comprising an appending unit to process the messages by adding further information to the messages, the appending unit being coupled to the Internet message server.

31. The system as claimed in claim 30, wherein the appending unit is identified by the message server using mailboxes and/or message channels.

32. The system as claimed in claim 30, wherein the appending unit forwards the message to a person and/or to further an apparatus present in the system.

33. The system as claimed in claim 32, wherein the person and/or an apparatus sends a message response and/or acknowledgement to the control and/or automation apparatus regarding the message forwarded by the appending unit.

34. The system as claimed in claim 24, wherein the message server is an Internet message server.

35. The system as claimed in claim 34, further comprising an address unit to assign the messages to at least one addressee.

36. The system as claimed in claim 35, wherein
the control and/or the automation apparatuses have a receiver to receive a confirmation message which is returned from the message server, and
the control and/or automation apparatuses have an acknowledgment unit to automatically mark a message as acknowledged.

37. The system as claimed in claim 36, further comprising an appending unit to process the messages by adding further information to the messages, the appending unit being coupled to the Internet message server.

38. The system as claimed in claim 37, wherein the appending unit is identified by the message server using mailboxes and/or message channels.

39. The system as claimed in claim 38, wherein the appending unit forwards the message to a person and/or to further an apparatus present in the system.

40. The system as claimed in claim 39, wherein the person and/or an apparatus sends a message response and/or acknowledgement to the control and/or automation apparatus regarding the message forwarded by the appending unit.

41. A method for processing messages, comprising:
sending messages from a plurality of control and/or automation apparatuses within a plant via a data transmission system;
receiving at a central message server the messages from all of the plurality of control and/or automation apparatuses within the plant, the message server being coupled to the data transmission system.

42. The method as claimed in claim 41, wherein the messages are transmitted via an intranet and/or an Internet as the data transmission system.

43. The method as claimed in claim 41, wherein the the central message server is an Internet message server.

44. The method as claimed in claim 43, wherein
the messages are interchanged asynchronously with the Internet message server, and
the Internet message server is an e-mail server.

45. The method as claimed in claim 43, wherein
the messages are interchanged synchronously with the Internet message server, and
the Internet message server is an instant messaging server.

46. The method as claimed in one of claims 41, wherein the messages are assigned to at least one addressee.

47. The method as claimed in claim 41, further comprising:
returning confirmation messages from the message server to the control and/or automation apparatuses; and
acknowledging the confirmation messages by the control and/or automation apparatuses.

48. The method as claimed in claim 41, further comprising processing the messages and adding additional information to the messages.

49. The method as claimed in claim 48, wherein
an appending unit processes and adds additional information to the messages, and
the message server identifies the appending unit using a mailbox and/or a message channel.

50. The method as claimed in claim 41, further comprising forwarding a message from the message server to a person and/or to another apparatus in the system.

51. The method as claimed in claim 41, wherein the person and/or other apparatus sends a, message response and/or an acknowledgement to the control and/or automation apparatus that originally sent the message.

52. The method as claimed in claim 42, wherein the the central message server is an Internet message server.

53. The method as claimed in one of claims 52, wherein the messages are assigned to at least one addressee.

54. The method as claimed in claim 53, further comprising:
returning confirmation messages from the message server to the control and/or automation apparatuses; and
acknowledging the confirmation messages by the control and/or automation apparatuses.

55. The method as claimed in claim 54, further comprising processing the messages and adding additional information to the messages.

56. The method as claimed in claim 55, wherein
an appending unit processes and adds additional information to the messages, and
the message server identifies the appending unit using a mailbox and/or a message channel.

57. The method as claimed in claim 56, further comprising forwarding a message from the message server to a person and/or to another apparatus in the system.

58. The method as claimed in claim 57, wherein the person and/or other apparatus sends a message response and/or an acknowledgement to the control and/or automation apparatus that originally sent the message.
